(19) United States
(12) Patent Application Publication
(10) Pub. No.: US 2005/0221136 A1
(43) Pub. Date: Oct. 6, 2005

(54) Charger, fuel cell system, and method of charring fuel cell system

(75) Inventors: Toru Nakakubo, TOKYO (JP); Ken Eguchi, Kanagawa (JP); Mitsuhiro Watanabe, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/510,215

(22) PCT Filed: Apr. 4, 2003
(86) PCT No.: PCT/JP03/04317

§ 371 Date: May 27, 2005

(30) Foreign Application Priority Data
Apr. 5, 2002 (JP) 2002-104442

(51) Int. Cl. H01M 8/06; H01M 8/04; C25B 9/00

(52) U.S. Cl. 429/21; 429/25; 429/26; 429/17; 204/275.1; 204/278

(57) ABSTRACT

Water is supplied to a fuel cell system, and electric power is supplied to a power intake electrode of the fuel cell system, whereby the water supplied to the fuel cell system is electrolyzed to generate hydrogen. Hydrogen as fuel can be filled in the fuel tank by supplying the generated hydrogen to the fuel tank.

### TECHNICAL FIELD

The present invention relates to a fuel cell system, a charger, and a method of charging the fuel cell system, and in particular, to a fuel cell system that supplies hydrogen, which is generated by electrolyzing water, to a fuel tank of the fuel cell system and stores the hydrogen therein, a charger, and a method of charging the fuel cell system.

### BACKGROUND ART

Conventionally, in order to carry and use small-sized electric appliances, various primary batteries and secondary batteries have been used. However, recently, in accordance with improvement in performance of the small-sized electric appliances, power consumption increases. Due to small size and lightweight, the primary batteries cannot supply sufficient energy. On the other hand, the secondary batteries have an advantage of being charged and used repeatedly. However, energy that can be used by charging at one time is still less than that of the primary batteries. In future, reduction in size and weight of electric appliances will advance and a wireless network environment will be improved, whereby tendency to carry and use the electric appliances will become stronger. Under such circumstances, it is difficult to supply energy sufficient for driving of the electric appliances with the conventional primary batteries and secondary batteries.

As a solution for such a problem, a small-sized fuel cell system attracts attentions. Conventionally, a fuel cell system has been developed as a drive source for large-sized generators and automobiles. This is primarily because the fuel cell system has high electrical efficiency and discharges clean wastes compared with other power generation systems. On the other hand, as a reason why the fuel cell system is useful as a drive source for small-sized electric appliances, an amount of energy, which the fuel cell system is capable of supplying per volume and per weight, is several times to ten times as large compared with the conventional batteries.

Fuel batteries of various systems have been invented. Among them, a proton exchange membrane fuel cell is suitable for small-sized electric appliances, in particular, electric appliances that are carried out and used. This is because the proton exchange membrane fuel cell has an advantage that the proton exchange membrane fuel cell can be used at temperature close to ordinary temperature and, in addition, can be carried safely since an electrolyte is solid rather than liquid.

For example, in the case where a fuel cell system is used as a power supply for a digital camera, photographing about three to five times as long is possible compared with the case where a conventional lithium ion battery is used.

However, although the fuel cell system has an extremely large amount of suppliable energy compared with secondary batteries such as a lithium battery, unlike the secondary batteries that are charged after discharge, fuel has to be supplied anew or the fuel cell system itself has to be replaced in the case where fuel in the fuel cell system is fully consumed. In the case where fuel or a fuel cell system is not obtained easily, electric power cannot be obtained.

### DISCLOSURE OF THE PRESENT INVENTION

In order to solve such problems, the present invention provides a fuel cell system that supplies hydrogen, which is generated by electrolyzing water, to a fuel tank of the fuel cell system and stores the hydrogen therein, a charger for charging the fuel cell system, and a method of charging the fuel cell system.

That is, according to one aspect of the present invention, there is provided a charger for generating hydrogen, which is stored in a fuel tank of a fuel cell system, by electrolyzing water in an inside of the fuel cell system, including: water supply means that supplies water to the fuel cell system; and power supply means that supplies electric power to a power intake electrode of the fuel cell system that takes in electric power for electrolyzing water supplied to the fuel cell system to generate hydrogen.

In further aspect of the charger, a power supply port of the power supply means is preferably connected to the power intake electrode of the fuel cell system in a state in which the power supply port and the power intake electrode are insulated from an outside.

In further aspect of the charger, the power supply means preferably includes: a plug for obtaining AC power supply from an outside; a DC converter for converting the AC power supply into a direct current; a transformer for transforming DC power supply into a voltage matched to a charging voltage of the fuel cell system; and a power supply port that supplies the transformed power supply to the power intake electrode of the fuel cell system.

In further aspect of the charger, the water supply means is preferably means that supplies water in a state in which the fuel cell system is immersed in the water.

In further aspect of the charger, the water supply means is preferably means that changes water into a mist state and supplies the water to the fuel cell system.

In further aspect of the charger, the charger preferably further includes a cooler that cools the fuel tank of the fuel cell system in a state in which the fuel cell system is attached to the charger.

In further aspect of the charger, the charger preferably further includes a heater that heats a cell section of the fuel cell system in a state in which the fuel cell system is attached to the charger.

In further aspect of the charger, the power supply means preferably further includes power control means that controls electric power to be supplied to the fuel cell system.

In further aspect of the charger, the power control means preferably controls electric power to be supplied to the fuel cell system on the basis of a signal from a pressure sensor provided in the fuel tank of the fuel cell system.

In further aspect of the charger, the charger preferably further includes valve control means that opens and closes a fuel supply valve provided in a fuel flow path, which introduces generated hydrogen to the fuel tank, on the basis of a signal concerning a pressure of hydrogen from a pressure sensor provided in the fuel tank of the fuel cell system.

In further aspect of the charger, the charger preferably further includes a residual capacity detecting means that displays a residual amount of fuel in the fuel tank of the fuel cell system on the basis of a signal concerning a pressure of hydrogen from a pressure sensor provided in the fuel tank of the fuel cell system.

According to another aspect of the present invention, there is provided a fuel cell system that stores hydrogen, which is generated by electrolyzing at least water supplied from an outside, in a fuel tank, including: a cell section including an oxidizer electrode (an electrode to which an oxidizer is supplied), a fuel electrode (an electrode to which fuel is supplied), and an ion conductor that is held between the oxidizer electrode and the fuel electrode; a water supply section that supplies water supplied from the outside to the ion conductor of the cell section; a power intake electrode that takes in electric power for electrolyzing water supplied from the water supply section to generate hydrogen from the outside; and a fuel tank in which the generated hydrogen is stored.

In further aspect of the fuel cell system, the water supply section preferably includes: a water retention section that retains the water supplied from the outside; and a water flow path that supplies water held in the water retention section to the ion conductor.

In further aspect of the fuel cell system, the water supply section preferably includes: a water retention section that retains the water supplied from the outside and water generated by discharge of the fuel electrode; and a water flow path that supplies the water held in the water retention section to the ion conductor.

In further aspect of the fuel cell system, the power intake electrode preferably serves as a power discharge electrode at the time of discharge of the fuel cell system.

In further aspect of the fuel cell system, the electric power from the outside taken in from the power intake electrode is preferably applied to the oxidizer electrode and the fuel electrode, and preferably electrolyzes the water supplied to the ion conductor.

In further aspect of the fuel cell system, the fuel cell system preferably further includes a pressure sensor that is provided in the fuel tank, and a signal concerning a pressure of hydrogen from the pressure sensor is preferably used for control of electric power to be supplied to the fuel cell system.

In further aspect of the fuel cell system, the fuel cell system preferably further includes: a pressure sensor that is provided in the fuel tank; and a fuel supply valve that is provided in a fuel flow path, which introduces generated hydrogen to the fuel tank, and is opened and closed on the basis of a signal concerning a pressure of hydrogen from the pressure sensor.

In further aspect of the fuel cell system, the fuel cell system preferably further includes: a pressure sensor that is provided in the fuel tank; and a residual capacity display section that displays a residual amount of fuel in the fuel tank of the fuel cell system on the basis of a signal from the pressure sensor.

In further aspect of the fuel cell system, the fuel cell system preferably further includes a cooler that cools the fuel tank.

In further aspect of the fuel cell system, the fuel cell system preferably further includes a heater that heats the cell section.

According to another aspect of the present invention, there is provided a fuel cell system that stores hydrogen, which is generated by electrolyzing water generated by discharge, including: a cell section including an oxidizer electrode (an electrode to which an oxidizer is supplied), a fuel electrode (an electrode to which fuel is supplied), and an ion conductor that is held between the oxidizer electrode and the fuel electrode; a water supply section that supplies water generated by discharge to the ion conductor of the cell section; a power intake electrode that takes in electric power for electrolyzing water supplied from the water supply section to generate hydrogen from the outside; and a fuel tank in which the generated hydrogen is stored.

In further aspect of the fuel cell system, the water supply section preferably includes: a water retention section that retains the water generated by discharge; and a water flow path that supplies water held in the water retention section to the ion conductor.

In further aspect of the fuel cell system, the power intake electrode preferably serves as a power discharge electrode at the time of discharge of the fuel cell system.

In further aspect of the fuel cell system, the electric power from the outside taken in from the power intake electrode is preferably applied to the oxidizer electrode and the fuel electrode, and preferably electrolyzes the water supplied to the ion conductor.

In further aspect of the fuel cell system, the fuel cell system preferably further includes a pressure sensor that is provided in the fuel tank, and a signal concerning a pressure of hydrogen from the pressure sensor is preferably used for control of electric power to be supplied to the fuel cell system.

In further aspect of the fuel cell system, the fuel cell system preferably further includes: a pressure sensor that is provided in the fuel tank; and a fuel supply valve that is provided in a fuel flow path, which introduces generated hydrogen to the fuel tank, and is opened and closed on the basis of a signal concerning a pressure of hydrogen from the pressure sensor.

In further aspect of the fuel cell system, the fuel cell system preferably further includes: a pressure sensor that is provided in the fuel tank; and a residual capacity display section that displays a residual amount of fuel in the fuel tank of the fuel cell system on the basis of a signal from the pressure sensor.

In further aspect of the fuel cell system, the fuel cell system preferably further includes a cooler that cools the fuel tank.

In further aspect of the fuel cell system, the fuel cell system preferably further includes a heater that heats the cell section.

According to another aspect of the present invention, there is provided a method of charging a fuel cell system that stores hydrogen, which is generated by electrolyzing supplied water, in a fuel tank, including: a step of supplying at least water supplied from an outside of the fuel cell system to an ion conductor constituting a cell section of the fuel cell system; a step of electrolyzing the water supplied to the ion conductor with electric power taken in from the outside of the fuel cell system to generate hydrogen; and a step of introducing the generated hydrogen to the fuel tank of the fuel cell system.

In further aspect of the method of charging a fuel cell system, the supplied water is preferably at least one of water supplied from the outside and water generated by discharge of the fuel cell system.

In further aspect of the method of charging a fuel cell system, the supplied water is preferably held by a water retention section and then supplied to the ion conductor through a water flow path.

In further aspect of the method of charging a fuel cell system, the fuel cell system preferably includes a power intake electrode for taking in electric power from the outside, and the power intake electrode preferably serves as a power discharge electrode at the time of discharge of the fuel cell system.

In further aspect of the method of charging a fuel cell system, electric power taken in from the outside is preferably applied to an oxidizer electrode (an electrode to which an oxidizer is supplied) and a fuel electrode (an electrode to which fuel is supplied), the electrodes constituting the cell section, and preferably electrolyzes the water supplied to the ion conductor.

In further aspect of the method of charging a fuel cell system, electric power supplied to the fuel cell system is preferably controlled on the basis of a pressure in the fuel tank.

In further aspect of the method of charging a fuel cell system, opening and closing of a fuel supply valve provided in a fuel flow path, which introduces generated hydrogen to the fuel tank, is preferably controlled on the basis of a pressure in the fuel tank.

In further aspect of the method of charging a fuel cell system, a residual amount of fuel in the fuel tank, which is calculated on the basis of a pressure in the fuel tank, is preferably displayed on a residual capacity display section.

In further aspect of the method of charging a fuel cell system, the fuel tank is preferably cooled.

In further aspect of the method of charging a fuel cell system, the cell section is preferably heated.

According to the present invention as described above, a charger and a fuel cell system that are capable of supplying hydrogen, which is generated by electrolyzing water, to a fuel tank of the fuel cell system can be provided. In addition, according to the method of charging the fuel cell system of the present invention, hydrogen, which is generated by electrolyzing water, can be supplied to the fuel tank of the fuel cell system.

Note that, in the present invention, charging indicates an act of supplying electric power to the fuel cell system, generating hydrogen by electrolyzing water, and storing the generated hydrogen in the fuel cell system. On the other hand, discharging indicates an act of generating electric power in an ion conductor of a cell portion using hydrogen.

Detailed modes of the present invention will be explained with reference to the drawings later.

### BRIEF DESCRIPTION OF THE DRAWINGS

FIG. 1 is a perspective view showing a fuel cell system in a first embodiment of the present invention.

FIG. 2 is a plan view of the fuel cell system in FIG. 1.

FIG. 3 is a front view of the fuel cell system in FIG. 1.

FIG. 4 is a perspective view showing a charger in the first embodiment of the present invention.

FIG. 5 is a plan view of the charger in FIG. 4.

FIG. 6 is a front view of the charger in FIG. 4.

FIG. 7 is a diagram showing a schematic example of a correlation of a system of the charger and the fuel cell system in the first embodiment of the present invention.

FIG. 8 is a perspective view showing a charger in a second embodiment of the present invention.

FIG. 9 is a plan view of the charger in FIG. 8.

FIG. 10 is a front view of the charger in FIG. 8.

FIG. 11 is a diagram showing a schematic example of a correlation of a system of the charger and the fuel cell system in the second embodiment of the present invention.

FIG. 12 is a diagram showing a positional relation between a water supply port and a water flow path of a fuel cell system in a third embodiment of the present invention.

FIG. 13 is a diagram showing a schematic example of a correlation of a system of a charger and a fuel cell system in the third embodiment of the present invention.

FIG. 14 is a diagram showing an appearance of a charger corresponding to a fuel cell system in which a water supply port position is a type of (a).

FIG. 15 is a plan view of the charger in FIG. 14.

FIG. 16 is a front view of the charger in FIG. 14.

FIG. 17 is a diagram showing a positional relation in the case where a fuel cell system 1 and a charge 2 are connected.

FIG. 18 is a front view of FIG. 17.

FIG. 19 is a diagram showing an outline of a water supply method in a fuel cell system.

FIG. 20 is a diagram showing a drainage pattern in an oxidizer electrode of a fuel cell system.

FIG. 21 is a schematic diagram showing a water supply method in a fuel cell system of water supply port (b) and water supply port (c) types in the third embodiment of the present invention.

FIG. 22 is a diagram showing a schematic example of a correlation of a system of a charger and a fuel cell system in a fourth embodiment of the present invention.

FIG. 23 is a diagram showing a schematic example of a correlation of a system of a charger and a fuel cell system in a fifth embodiment of the present invention.

FIG. 24 is a flowchart showing an example of an operation method for the charger in the first embodiment.

FIG. 25 is a conceptual diagram showing a digital camera mounted with the fuel cell system of the present invention.

### BEST MODE FOR CARRYING OUT THE PRESENT INVENTION

(Charger)

First, a charger of the present invention will be explained. The charger of the present invention generates hydrogen, which is supplied to and stored in a fuel tank of a fuel cell system, by electrolyzing water in the inside of the fuel cell system. The charger includes water supply means that supplies water to the fuel cell system and power supply means that supplies electric power to a power intake electrode of the fuel cell system and electrolyzes water supplied to the fuel cell system to generate hydrogen. It is preferable that the charger includes holding means for holding the fuel cell system.

The power intake electrode may also serve as a power discharge electrode (which may also be referred to a power taking-out electrode). In this case, at the time of discharge of the fuel cell system, the power intake electrode can function as the power discharge electrode (power taking-out electrode) for taking out generated electric power to the outside of the fuel cell system.

According to such a structure, it is possible to supply water to a fuel cell and apply a voltage to the power intake electrode of the fuel cell system to thereby supply electric power to a fuel cell electrode and store the generated hydrogen in a fuel tank of the fuel cell system. In the case where the charger includes the holding means for holding the fuel cell system, the charger may supply water and electric power to the cell via the holding means.

It is preferable to insulate a contact point of a power supply port of the charger and the power intake electrode of the fuel cell system from the outside.

It is advisable that the power supply means includes a DC converter for converting AC power from a power line into a direct current and a transformer for transforming a voltage to a voltage appropriate for charging of the fuel cell system.

In addition, the charger may include a water tank for storing water.

As the water supply means, there are, for example, one that has a water bath in which the fuel cell (The fuel cell includes an oxidizer electrode, a fuel electrode, and an ion conductor held between the oxidizer electrode and the fuel electrode. The oxidizer electrode refers to an electrode to which an oxidizer is supplied, and the fuel electrode refers to an electrode to which fuel is supplied) is immersed in water and one that changes water into a mist state and supplies the water to the fuel cell. As means for changing water into a mist state, there are a heater and an ultrasonic vibrator serving as vibrating means that vibrates water and changes the water into a mist state. It is preferable that the water supply means includes a water supply port that is connectable to a flow path for water leading to the fuel cell.

The charger may include drying means for drying the inside of the fuel cell system. In supplying water to the fuel cell system, water leaked to the inside of the fuel cell system can be removed. As the drying means, there is air sending means, and more preferably, air sending means for sending hot wind.

It is preferable that the charger includes a heater for heating the ion conductor (e.g., a polymer electrolyte membrane) of the fuel cell system. Water to be supplied to the ion conductor may be heated in advance. The charger may include temperature adjusting means for adjusting temperature of the heater. Temperature of the ion conductor can be maintained at predetermined temperature, for example, 60° C. to 90° C.

The charger may include a cooler for cooling the fuel tank of the fuel cell system. Further, the charger may include valve control means that controls opening and closing of a fuel supply valve provided between the fuel tank and a power generation cell of the fuel cell system. As a method of controlling the valve, there are a method of sending an electric signal to the valve and a method of mechanically operating the valve.

Moreover, it is preferable that the charger includes residual capacity detecting means that detects a fuel capacity of the fuel cell system, charge ending means for ending charging of the fuel cell system on the basis of a result of the detection of this residual capacity detecting means, charge ending display means that informs that charging has ended, and the like. As the residual capacity detecting means, for example, there is a fuel pressure sensor provided in the fuel cell system.

(Fuel Cell System)

Next, the fuel cell system of the present invention will be explained.

The fuel cell system of the present invention is capable of electrolyzing at least water supplied from the outside and storing generated hydrogen in a fuel tank, and characterized by including a water supply section that supplies the water supplied from the outside to an ion conductor (e.g., a polymer electrolyte membrane) in a cell section and a power-intake power that takes in electric power for electrolyzing the water supplied to the water supply section to generate hydrogen. The cell section includes an oxidizer electrode (an electrode to which an oxidizer is supplied), a fuel electrode (an electrode to which fuel is supplied), and an ion conductor held between the oxidizer electrode and the fuel electrode. As the fuel cell system, there are a proton exchange membrane fuel cell and the like.

Note that, as described above, the power intake electrode may also serve as a power discharge electrode (which may also be referred to a power taking-out electrode). In this case, at the time of discharge of the fuel cell system, the power intake electrode can function as the power discharge electrode (power taking-out electrode) for taking out generated electric power to the outside of the fuel cell system.

As the water supply portion, there is one including a water supply port for supplying water from the outside to the ion conductor (e.g., a polymer electrolyte membrane) in the power generation cell (cell section) and a water flow path leading to the ion conductor and the oxidizer electrode from the water supply port.

It is preferable that the fuel cell system includes a water retention section in contact with the ion conductor. The water retention section plays a role of a water flow path for guiding water supplied from the outside to the ion conductor and the oxidizer electrode. As a material for the water retention section, a material having a water absorbing property is used.

It is preferable that the fuel cell system includes an auxiliary water flow path composed of a material having a hydrophilic property. The auxiliary water flow path can be provided in, for example, the ion conductor. It is advisable that the water retention section is constituted so as to supply water contained therein to the auxiliary water flow path. The water contained in the water retention section is supplied to the ion conductor (e.g., a polymer electrolyte membrane) by the capillary action or the like.

Water contained in the auxiliary water flow path is supplied to the ion conductor by the capillary action. The water retention section may be provided in a position in contact with the oxidizer electrode and the ion conductor. As water supplied to the ion conductor, water generated in the oxidizer electrode of the cell section may be used. For example, the generated water is stored in the water retention section and supplied to the ion conductor by the capillary action through the water retention section or through the water retention section and the auxiliary water flow path.

It is preferable that the power taking-out electrode of the fuel cell system is insulated from water for charging. In addition, the fuel cell system may include a heater for heating the ion conductor (e.g., a polymer electrolyte membrane).

(Charging Method)

Next, the charging method for the fuel cell system of the present invention will be explained.

The charging method for the fuel cell system of the present invention includes electrolyzing at least water supplied from the outside and storing generated hydrogen in a fuel tank, and is characterized by further including supplying at least the water supplied from the outside to an ion conductor (e.g., a polymer electrolyte membrane), generating hydrogen by electrolyzing the water supplied to the ion conductor using a power taken from outside by the power taking-out electrode, and introducing the generated hydrogen into the fuel tank of the fuel cell system.

The present invention will be hereinafter explained more specifically on the basis of the drawings.

### First Embodiment

A first embodiment of the present invention will be explained. In the first embodiment, water is supplied by directly immersing a cell of a fuel cell system in the water.

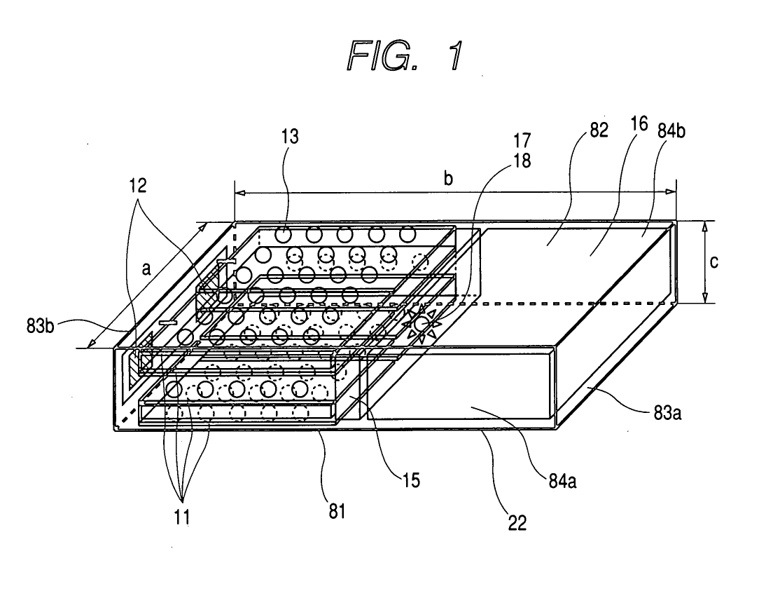

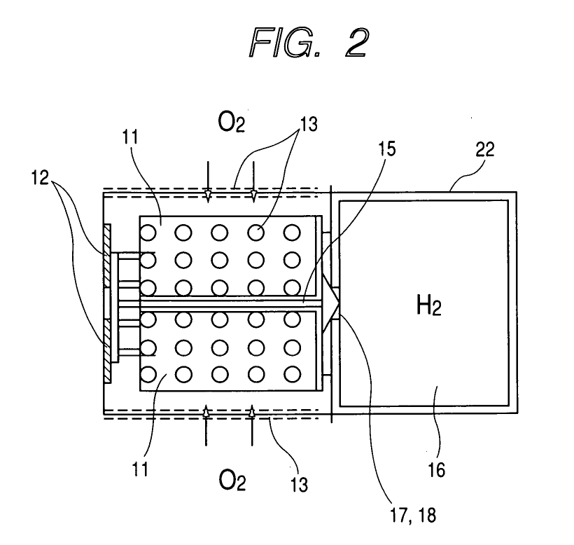

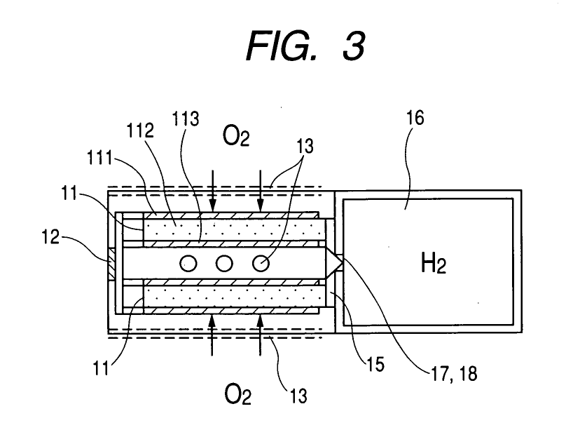

FIG. 1 is a perspective view showing an example of the fuel cell system of the present invention. FIG. 2 is a plan view of the fuel cell system in FIG. 1. FIG. 3 is a front view of the fuel cell system in FIG. 1. An example of an external dimension of the fuel cell system of the present invention shown in FIG. 1 has length (a) 30 mm×width (b) 50 mm×height (c) 10 mm, which is substantially the same size of a lithium ion battery usually used in a compact digital camera.

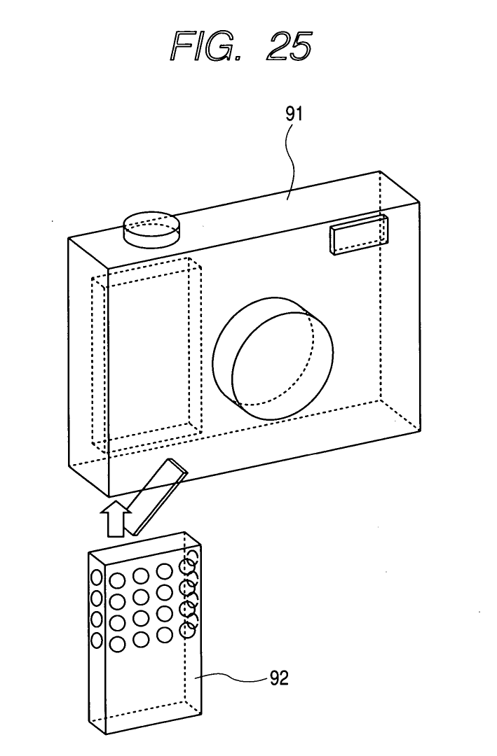

FIG. 25 is a schematic diagram showing a digital camera mounted with the fuel cell system of the present invention. As shown in FIG. 25, since a digital camera 91, which is one of small-sized electric appliances mounted with the fuel cell system of the present invention, is small in size and integrated, a small-sized fuel cell system 92 is formed in a shape easily incorporated in a digital camera as a portable device. In addition, a thin rectangular parallelepiped shape of the fuel cell system is easily incorporated in small-sized electric appliances compared with a thick rectangular parallelepiped or cylindrical shape.

Since this fuel cell system takes in oxygen, which is used for reaction as an oxidizer, from the outside air, the fuel cell system has vent holes 13 etc. for taking in the outside air on an upper surface 82, a lower surface 81, and long sides 84a and 84b of a housing 22 as shown in FIG. 1. The vent holes 13 also perform action for releasing generated water as steam and releasing heat generated by reaction to the outside. In addition, power taking-out electrodes (hereinafter also referred to as electrodes) 12 for taking out electric power are provided on one short side 83b of the housing 22.

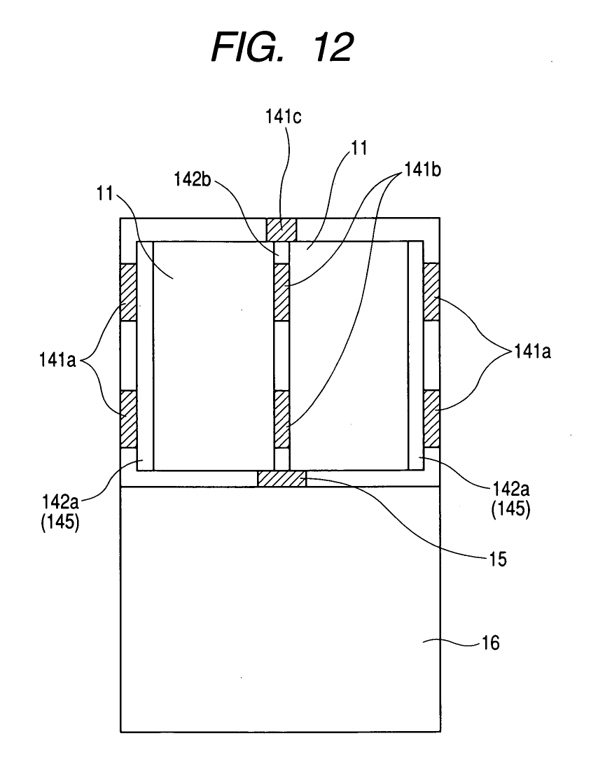

On the other hand, as shown in FIG. 3, the inside of the hosing 22 is constituted by: sell sections (fuel cells) 11 including one or more cells composed of fuel electrodes 113 (electrodes to which fuel is supplied), ion conductors (e.g., polymer electrolyte membranes) 112, oxidizer electrodes 111 (electrodes to which an oxidizer is supplied), and a catalyst (not shown); a fuel tank 16 in which fuel is stored; a fuel supply path 15 that connects the fuel tank and the fuel electrode of each cell; and a pressure sensor 17 that measures a pressure of the fuel. In addition, in the case where an amount of water generated in accordance with power generation is large, the housing may include a drainage retention section 145 (see FIG. 12) in which the generated water is stored.

The fuel cell has an electromotive force of 0.8 V and a current density of 300 mA/cm², and a size of a unit cell is 1.2 cm×2 cm. By connecting eight fuel cells in series, an output of the entire battery is 4.6 W at 6.4 V and 720 mA.

Next, the fuel tank 16 will be explained. A hydrogen occlusion alloy capable of occluding hydrogen is filled inside the fuel tank. Since a withstand pressure of an ion conductor used in the fuel cell system is 0.3 to 0.5 MPa, the fuel cell system in a range in which a pressure difference from the outside air is within 0.1 MPa may be used.

As a hydrogen occlusion alloy having a characteristic with a releasing pressure of hydrogen under an ordinary temperature of 0.2 Mpa, for example, LaNi₅ is used. When it is assumed that a capacity of the fuel tank is half the entire fuel cell system, a tank thickness is 1 mm, and a tank material is titanium, a weight of the fuel tank is about 50 g, and a volume of the fuel tank is 5.2 cm³. Since LaNi₅ is capable of absorbing and desorping hydrogen of 1.1 wt % per weight, an amount of hydrogen stored in the fuel tank is 0.4 g, energy that can be generated is about 11.3 [W·hr], which is about four times as large as that of the conventional lithium ion battery.

On the other hand, in the case where a hydrogen occlusion material with a releasing pressure of hydrogen under the ordinary temperature exceeding 0.2 Mpa is used, it is necessary to provide a decompression valve 18 between the fuel tank and the fuel electrodes.

Hydrogen stored in the tank is supplied to the fuel electrodes 113 through the fuel supply path 15. The outside air is supplied to the oxidizer electrode 111 from the vent holes 13. Electric power generated by the fuel cell is supplied to the small-sized electric appliance from the electrode 12 (see FIG. 3). In addition, to prevent the electrodes of the fuel cell system from becoming conductive via water for electrolysis at the time when the fuel cell system is charged, parts of the respective electrodes to be in contact with the water are insulated. As an insulation method, there is a method of coating parts of the electrodes, which are not in contact with the ion conductor, with an insulator.

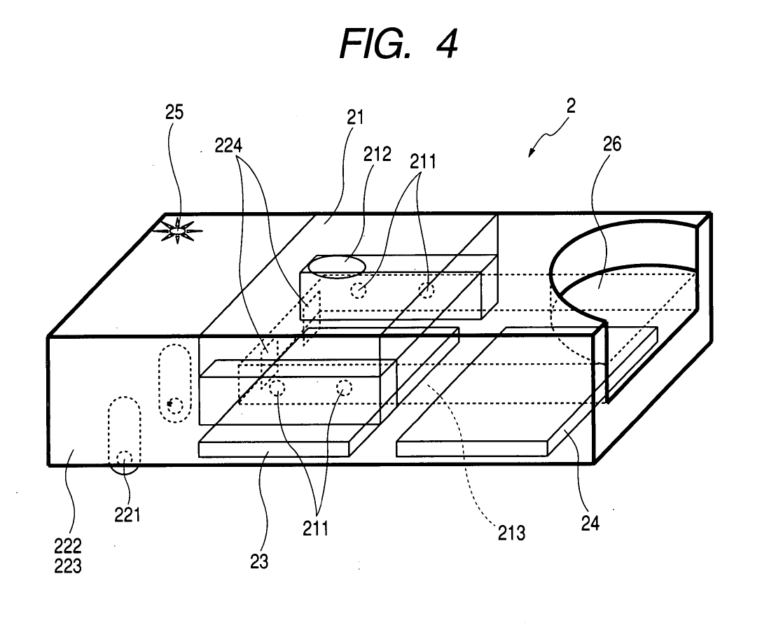

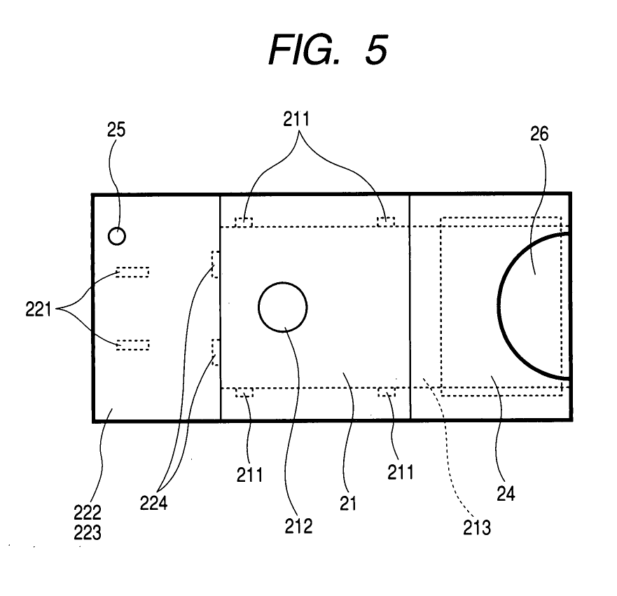

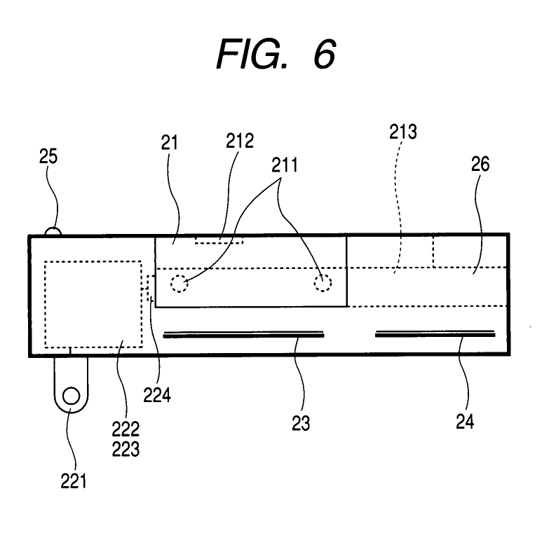

FIG. 4 is a perspective view showing an example of the charger of the present invention. FIG. 5 is a plan view of the charger of the present invention in FIG. 4, and FIG. 6 is a front view of the charger of the present invention. A charger 2 includes a fuel cell system insertion opening 26 for connecting the charger 2 with a fuel cell system, a power supply plug 221 for obtaining electric power necessary for charging from a power line such as a plug socket for home use, a DC converter (AC/DC converter) 222 that converts electric power from the power supply plug 221 into a direct current, a transformer 223 that transforms a voltage into a voltage optimum for charging, a water tank 21 in which water for electrolysis is stored, a water feeding port 212 for feeding water to the water tank 21, a water bath 213 for immersing a fuel cell in water, water supply ports 211 for supplying water from the water tank to the water bath 213, and a residual amount display section 25 that informs progress and end of charging. It is also possible to use the same member for the water tank 21 and the water bath 213. In addition, the charger 2 can include a valve opening and closing mechanism for opening and closing a valve of a fuel cell, a heater 23 for heating an ion conductor (e.g., a polymer electrolyte membrane) of the fuel cell system, and a cooler 24 for cooling the fuel tank of the fuel cell system as required.

To insert a fuel cell system into the charger of the present invention shown in FIG. 4, the fuel cell system is inserted into the charger from the fuel cell system insertion opening 26 to be housed in an area of the water bath 213 indicated by a dotted line. The fuel cell system is housed such that a cell section of the fuel cell system is arranged in the position of the heater 23 and a fuel tank of the fuel batter is arranged in the position of the cooler 24. Water is supplied to an area surrounded by the water tank 21 of the charger in a C shape (the water bath 213) from the water tank via the water supply port 211. The fuel cell system comes into a state in which the fuel cell system is immersed in the water in the water bath. The water in the water bath reaches the cell section through vent holes (water supply ports) of the fuel cell system. In the first embodiment, the vent holes are used as the water supply ports.

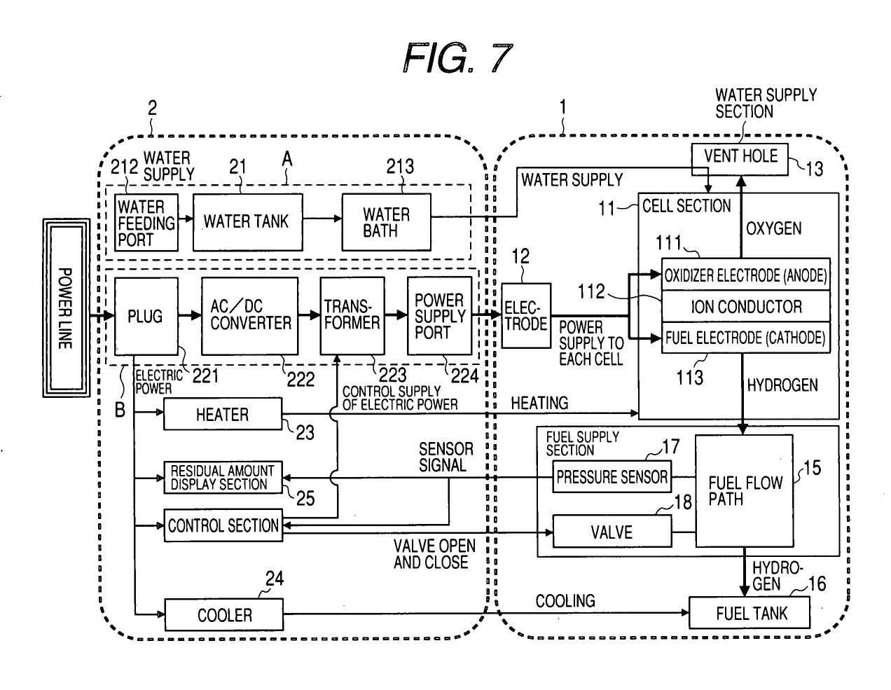

A charging method using the charger of the present invention will be hereinafter explained. FIG. 7 is a diagram showing a schematic example of a correlation of a system in the case where a fuel cell system 1 and the charger 2 are connected. Reference symbol A denotes water supply means and B denotes power supply means. First, the fuel cell system 1 is inserted into the charger 2 from the fuel cell system insertion opening 26, pure water is poured into the water tank 21 from the water feeding port 212, and the plug 221 is plugged into a socket of a power line. Since an amount of hydrogen that can be stored in the fuel tank 16 of the fuel cell system 2 is 0.4 g, an amount of water necessary for charging is about 3.8 cm³. Electric power supplied from the power line is converted into a direct current by the DC converter (AC/DC converter) 222 and further transformed by the transformer 223. A voltage necessary for electrolysis of water is about 3 V per one ion conductor. The transformed electric power is supplied from a power supply port 224 of the charger to the power taking-out electrode 12 of the fuel cell system, and a positive current is supplied to the oxidizer electrode (an electrode to which an oxidizer is supplied) 111 of the sell section 11 and a negative current is supplied to the fuel electrode (an electrode to which fuel is supplied) 113. In other words, in charging, the oxidizer electrode 111 works as an anode for electrolysis of water, and the fuel electrode 113 works as a cathode.

Note that a fuel cell system may have an electrode for taking in electric power from a charger (a power intake electrode) separately from a power taking-out electrode. On the other hand, as in the first embodiment, the power intake electrode may also serve as a power discharge electrode (the power taking-out electrode). According to the first embodiment, at the time of discharge for the fuel cell system, the power taking-out electrode functions as an electrode for taking out generated electric power to the outside of the fuel cell system, and at the time of charging for the fuel cell system, the power taking-out electrode functions as an electrode for taking in electric power from the charger.

When the electric power is supplied to the fuel cell system, charging for the fuel cell system is started. In the oxidizer electrode functioning as the anode for electrolysis of water, reaction of formula (1) described below is caused by water supplied to an ion conductor (e.g., a polymer electrolysis film) and a positive current supplied from the power supply port, and oxygen and hydrogen ions are generated. On the other hand, in the fuel electrode functioning as the cathode for electrolysis of water, reaction of formula (2) described below is performed by the hydrogen ions generated in the ion conductor and a negative current supplied from the power supply port, and hydrogen is generated. The hydrogen generated in the fuel electrode is housed in the fuel tank through the fuel supply path and stored as fuel.

Oxidizer Electrode (Anode):
2H₂O→O₂+4H⁺+4e⁻ (1)

Fuel Electrode (Cathode):
4H⁺+4e⁻=→2H₂ (2)

Note that, in a state in which the fuel cell system is generating electric power, the oxidizer electrode functions as a cathode and the fuel electrode functions as an anode. For reference, reaction formulas (3) and (4) in the respective electrodes are indicated below.

Oxidizer Electrode (Cathode)
O₂+4H⁺+4e⁻→2H₂O (3)

Fuel Electrode (Anode)
2H₂→>4H⁺+4e⁻ (4)

Water necessary for charging is supplied as described below. First, the water stored in the water tank 21 is sent to the water bath 213. The water in the water bath 213 is taken into the inside of the fuel cell system from the vent holes 13 for taking in the outside air necessary for power generation of the fuel cell system and supplied to an interface of the oxidizer electrode 111 and the ion conductor 112.

Nafion 117 or the like can be used as the ion conductor 112. In this case, when a voltage between the anode and the cathode is 3 V, a flowing current is 1 A/cm² at 25° C. Since a size of a cell is 1.2 cm×2 cm, a total area when eight cells are used is 19.2 cm², and a flowing current is 19.2 A. A generation amount of hydrogen at this time is 3.4×10⁻⁵ g per second.

In the case where the fuel cell system has a valve 18, the valve 18 is opened by a valve opening and closing mechanism of a control section. A valve driving method varies depending upon a type of a valve. For example, in the case where the valve 18 is an electromagnetic valve, there is a method of applying electric power to the valve. In addition, in the case where the valve 18 is a mechanically driven valve, there is a method of mechanically applying power to a valve drive section using a pin or the like. The valve can be opened and closed by the pin or the like.

Progress of charging may be monitored according to a value of the pressure sensor 17 mounted on the fuel cell system. In the case where a value of the pressure sensor has exceeded a fixed value (e.g., about 0.2 MPa), a charging stop signal is sent to the charger to disconnect a circuit and stop the charging, and an indication of the end of charging is shown on the residual amount display section 25. In this way, overcharge can be prevented and an internal pressure of the fuel tank can be prevented from becoming high. In the case where the fuel cell system has the valve 18, the valve is closed by the valve opening and closing mechanism simultaneously with the end of charging.

When the polymer electrolyte membrane serving as the ion conductor 112 is heated to 80° C. using the heater 23, a flowing current rises to about 3 A/cm², efficiency of charging is improved, and the charging ends in about one hour in this case. As means for heating an ion conductor, there is also a method of heating water to be supplied to the fuel cell system with a heater and supplying hot water to the fuel cell. In addition, the heater can also be mounted on the fuel cell system. In this case, electric power necessary for the heater may be supplied from the electrode 12. Further, the heater mounted on the fuel cell system can be used for improving efficiency of power generation of the fuel cell system and supporting driving under low temperature.

By cooling the fuel tank using the cooler 24, it is possible to decrease a releasing pressure of a hydrogen occlusion alloy in the fuel tank to facilitate an electrolysis reaction and prevent a hydrogen pressure in the fuel tank from becoming excessive.

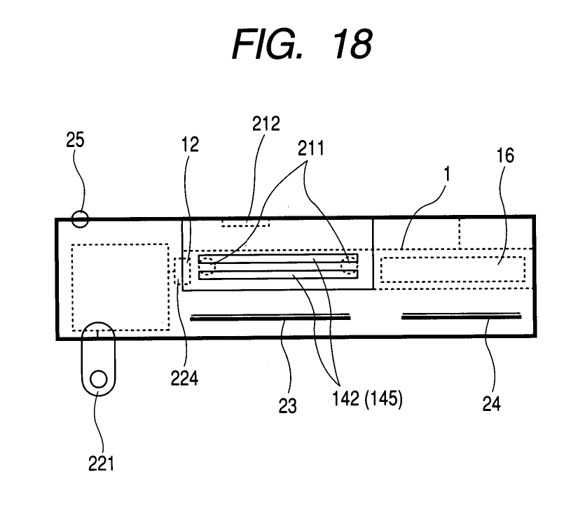

In a proton exchange membrane fuel cell, it is necessary that the polymer electrolyte membrane 112 serving as an ion conductor is wet moderately. If the charger of the present invention is used, it is possible to humidify the solid ion conductor via a water flow path 142 (see FIG. 18) communicated with the cell section. In addition, water is generated in the oxidizer electrode 111 upon power generation (discharge) of the fuel cell system. It is possible to use this water as water for charging as well.

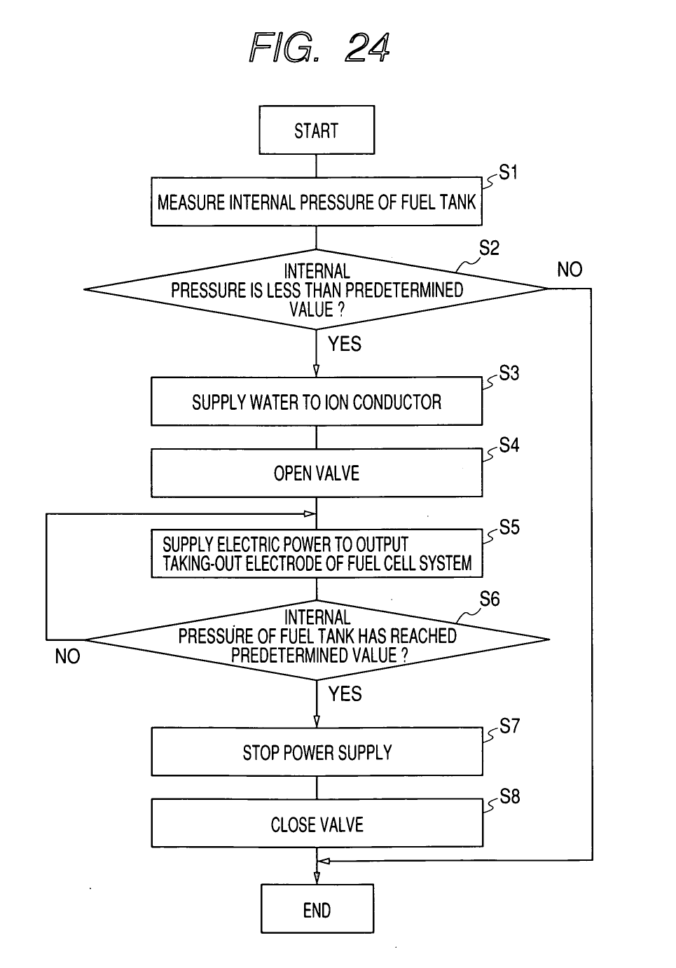

FIG. 24 is a flowchart showing an example of an operation method for the charger in this embodiment. The series of charging flow will be explained along the flowchart.

First, an internal pressure of the fuel tank is measured by the pressure sensor (step S1). If the internal pressure is less than a predetermined value (step S2), water is supplied to the ion conductor in the cell section (step S3). Then, the valve to the fuel tank is opened (step S4), and electric power is supplied from the power supply means of the charger to the power taking-out electrode of the fuel cell (step S5). If the internal pressure of the fuel tank has reached the predetermined value (step S6), supply of electric power to the power taking-out electrode of the fuel cell system is stopped (step S7), and the valve is opened (step S8) to end the charging flow.

Note that, in step S2, if the internal pressure of the fuel tank is equal to or higher than the predetermined value (step S2), the charging flow is ended. This is because it is unnecessary to supply hydrogen if the internal pressure of the fuel tank is sufficiently high. In addition, this is also for preventing the pressure of the fuel tank from becoming excessively high.

In addition, in step S6, if the internal pressure of the fuel tank has not reached the predetermined value (S6), since an amount of hydrogen in the fuel tank is not sufficient, electric power supply to the fuel cell system is continued (S5). Therefore, a sufficient amount of hydrogen is stored in the fuel tank.

### Second Embodiment

A second embodiment of the present invention will be explained. In this embodiment, water to be used for charging is changed into a mist state to be supplied to a fuel cell.

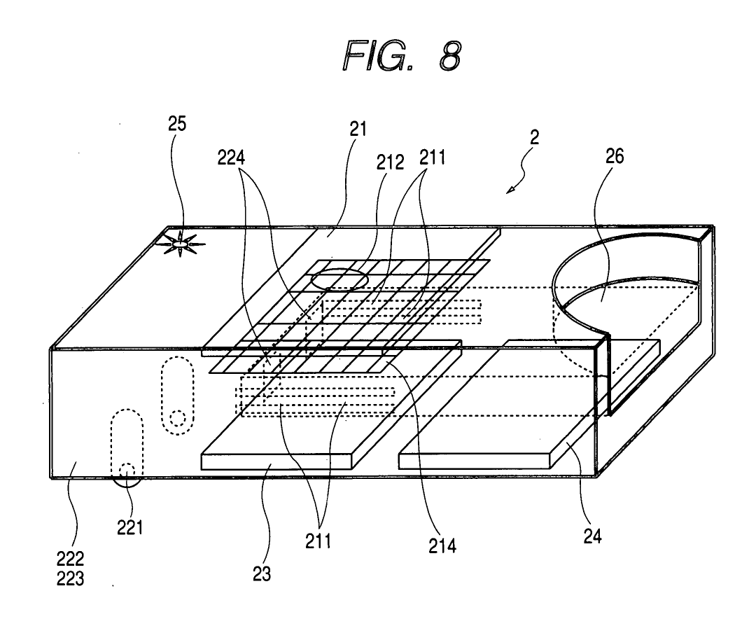

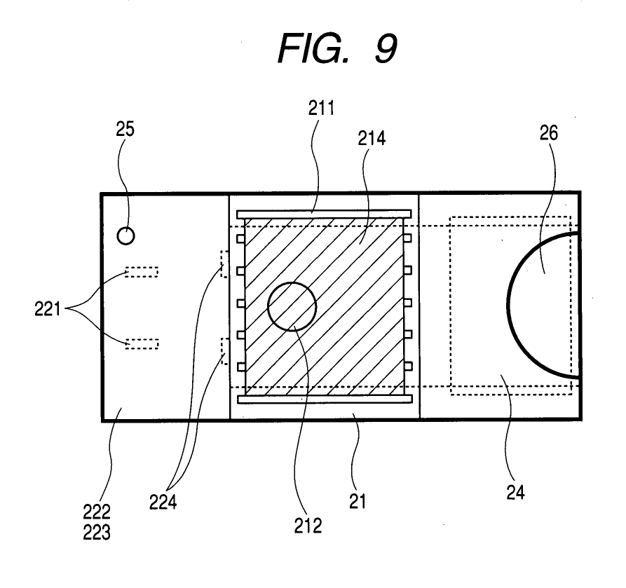

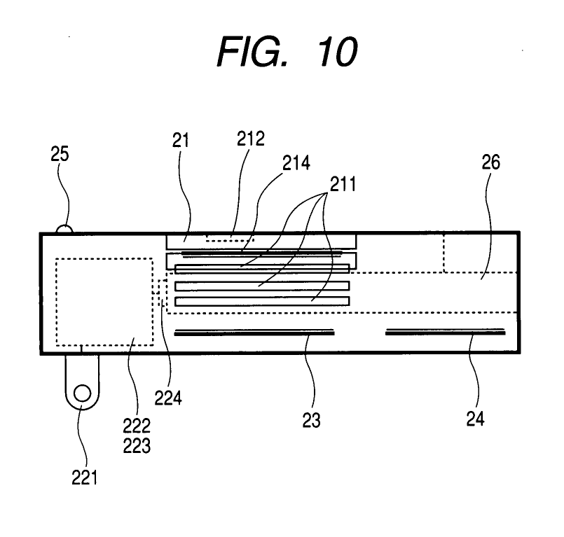

FIG. 8 is a perspective view showing an example of the charger of the present invention. FIG. 9 is a plan view of the charger of the present invention in FIG. 8, and FIG. 10 is a front view of the charger of the present invention in FIG. 8. Water stored in the water tank 21 is vibrated by a vibration element 214 to be changed into a mist state and supplied to a fuel cell system. It is also possible to heat water using a heater instead of the vibration element to change the water into a mist state. The water in the mist state reaches a cell section through vent holes (water supply ports) of the fuel cell system. In a form shown in FIG. 8, the vent holes of the fuel cell system are used as water supply ports.

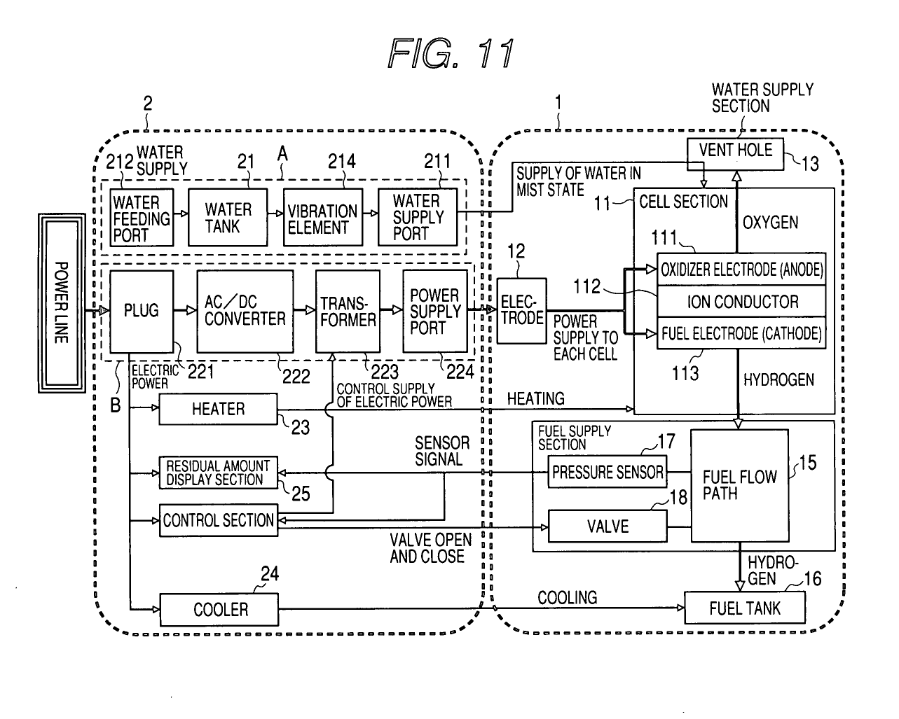

FIG. 11 is a diagram showing another schematic example of a correlation of a system of the charger and the fuel cell system of the present invention. FIG. 11 shows a system of the charger and the fuel cell system in the case where water is changed into a mist state and supplied to the fuel cell system from the charger. The other components are the same as those in FIG. 7.

### Third Embodiment

A third embodiment of the present invention will be explained. In this embodiment, water used for charging is supplied to a fuel cell via a flow path.

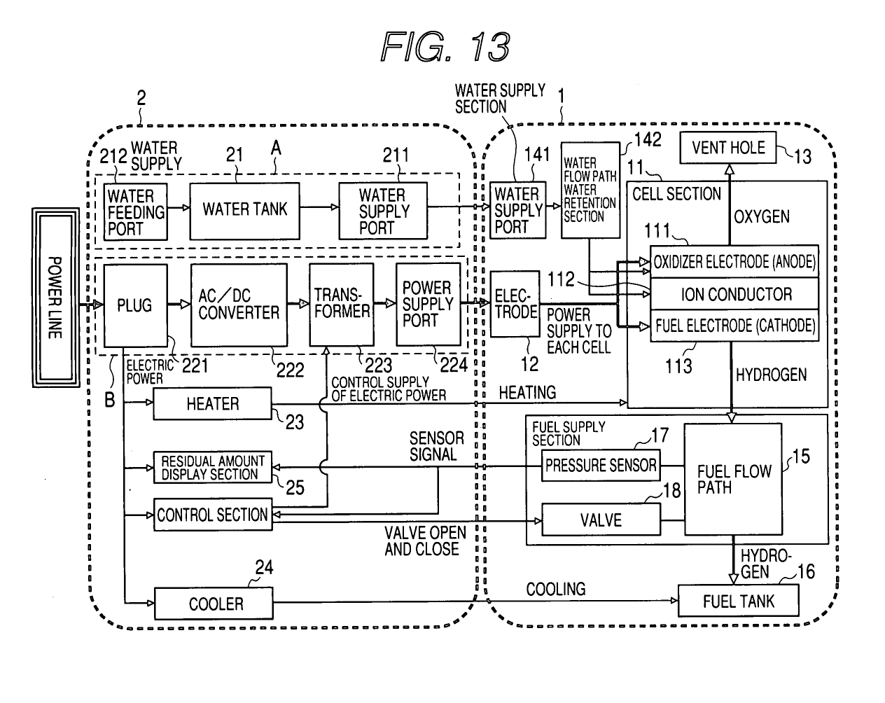

FIG. 13 is a diagram showing another schematic example of a correlation of a system of the charger and the fuel cell system of the present invention. In FIG. 13, a water supply port 141 for taking in water from the outside and a water flow path 142, which supplies water to the oxidizer electrode 111 and the ion conductor (polymer electrolyte membrane) 112 of the cell, are added to the fuel cell system. As a positional relation between the water supply port 141 and the water flow path 142 shown in FIG. 13, for example, there is a system as shown in FIG. 12. FIG. 12 shows an example of the fuel cell system. The example indicates a case (a) where a water supply port 141a and a water flow path 142a are in contact with a side where a drainage retention section 145 of the fuel cell is provided (both side parts in FIG. 12), a case (b) where a water supply port 141b and a water flow path 142b are in positions in contact with oxidizer electrodes on an upper surface and a lower surface of the battery cell (a center part in FIG. 12), and a case (c) where a water supply port 141c is on an opposite side of the drainage retention section 145 on a side of the battery cell (an upper part in FIG. 12). Note that the drainage retention section is a member that retains water generated in the fuel cell (also referred to as a cell section).

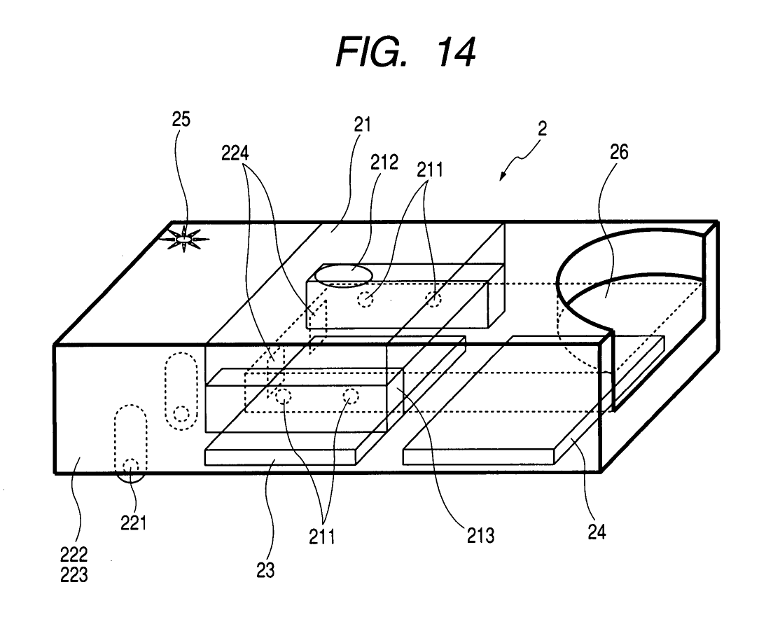

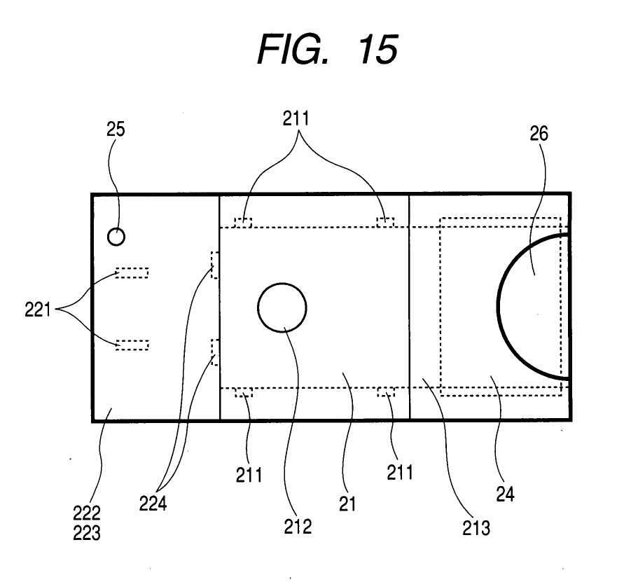

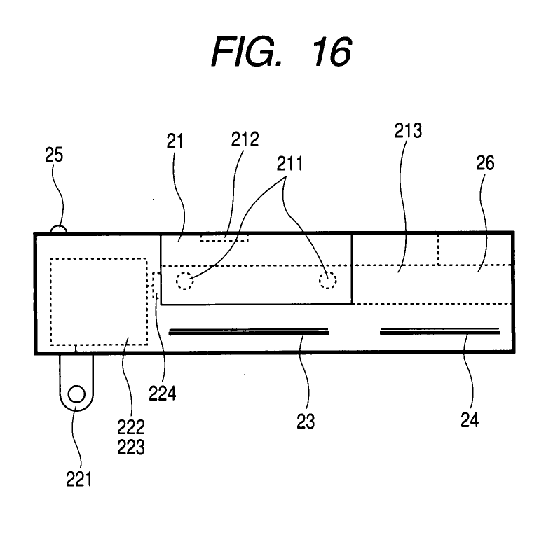

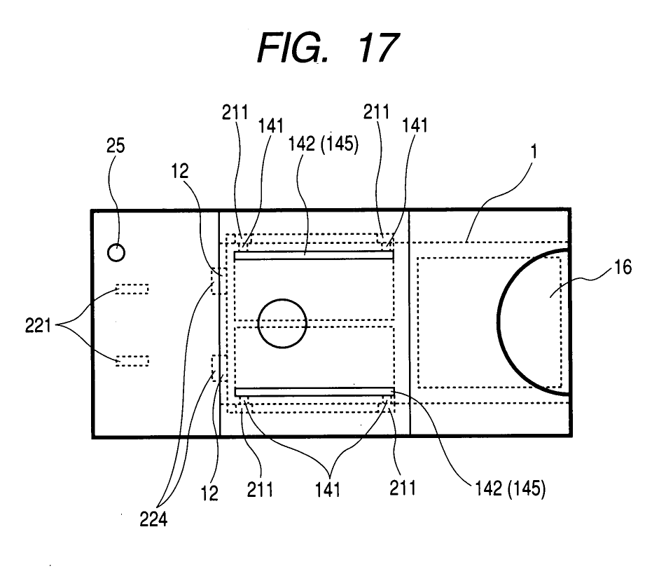

The case in which the water supply port and the water flow path are in the position of (a) will be hereinafter explained. FIG. 14 is a diagram showing an appearance of a charger corresponding to a fuel cell system with the water supply port position of (a). In addition, FIG. 15 is a plan view of the charger in FIG. 14. FIG. 16 is a front view of the charger in FIG. 14. The charger 2 includes the water supply ports 211 for supplying water to the water supply ports 141 (see FIG. 17) of the fuel cell system. FIG. 17 is a diagram showing a positional relation in the case where the fuel cell system 1 and the charger 2 are connected. FIG. 18 is a front view of FIG. 17.

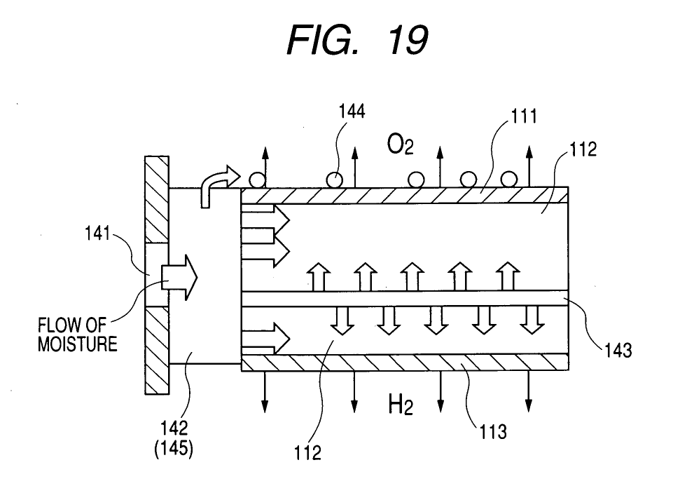

Water stored in the water tank 21 is supplied from the water supply ports 211 of the charger to the water supply ports 141 of the fuel cell system and further supplied to the oxidizer electrode 111 and the ion conductor 112 through the water flow path 142. FIG. 19 is a diagram showing an outline of a water supply method in the fuel cell system. Outlined arrows indicate the flow of the water supplied from the water supply ports 141. Reference numeral 144 denotes water generated in the oxidizer electrode. The water flow path (including a drainage retention section in FIG. 19) 142 is formed of a porous member, and water is supplied to the oxidizer electrode 111 and the ion conductor (polymer electrolyte membrane) 112 using the capillary action, whereby the overflow of the water in the fuel cell can be prevented. As a material of the water flow path 142, an organic material or an inorganic material is used. As the organic material, there are polymers having hydrophilic property such as an acrylic group, an amide group, an ether group, and a carboxyl group, for example, there are polyacrylamide gel and the like. In addition, as the inorganic material, there are silica gel, zeolite, and the like.

Regarding the type with a position of the water supply ports 141 of (a), the drainage retention section 145 for storing water generated in power generation (discharge) of the fuel cell system can be used as this fuel flow path.

In the case where a cell area is large and sufficient water cannot be supplied to the ion conductor (polymer electrolyte membrane) only by natural diffusion, at least one auxiliary water flow path 143 made of a hydrophilic material, which is connected to a water retention section, is provided in the ion conductor 112, whereby water diffuses rapidly into the ion conductor 112 through the auxiliary water flow path 143, and the water can be supplied sufficiently without using a pump or the like.

As the material used for the auxiliary water flow path 143, a material having the hydrophilic property is used. For example, as the organic material, there is a styrene compound having a sulfonic group in a side chain, and as the inorganic material, there is a material obtained by adding a phosphoric acid group to silica sol-gel. In addition, a method of arranging the auxiliary water flow path in the ion conductor can be carried out by, for example, nipping the auxiliary water flow path with an ion conductor material.

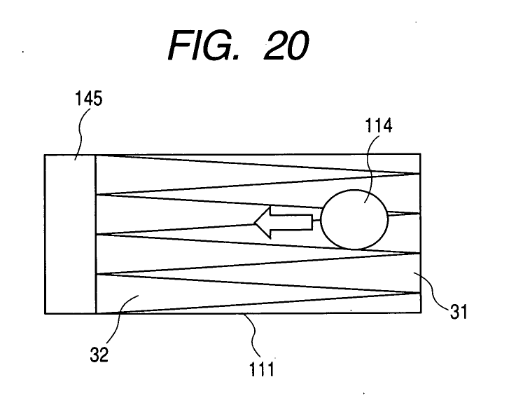

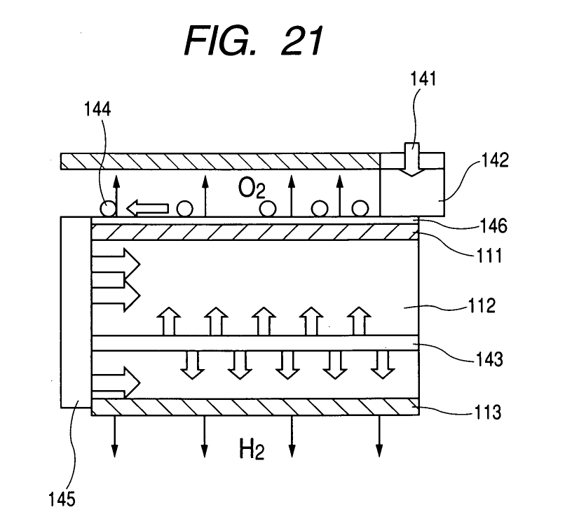

FIG. 20 is a diagram showing a drainage pattern in an oxidizer electrode. Reference numeral 31 denotes a hydrophilic area; 32, a hydrophilic area; 111, an oxidizer electrode; 114, water; and 145, a drainage retention section. Water is generated on a surface of the oxidizer electrode in power generation (discharge) of the fuel electrode. In the case where hydrophobic and hydrophilic treatments as shown in FIG. 20 are applied to the surface of the oxidizer electrode in order to guide this water generated in power generation (discharge) promptly to the drainage retention section, the water flows in a part subjected to the hydrophobic and hydrophilic treatments indicated by an arrow. Therefore, in the type with a water supply port position of (a), it may be difficult to supply water to the interface of the oxidizer electrode and the ion conductor. Thus, in such a case, it is effective to provide a water supply port and a water retention section in the position of (b), that is, on the opposite side of the drainage retention section and in contact with the surface of the oxidizer electrode. FIG. 21 shows a flow of water in the cell in this case. Water supplied from the water flow path 142 flows to the drainage retention section 145 on the surface of the oxidizer electrode. During the flow of the water, an electrolysis reaction occurs. Reference numeral 111 denotes an oxidizer electrode; 112, an ion conductor; 113, a fuel electrode; 141, a water supply port; 143, an auxiliary water flow path; 146, a drainage pattern formed by the hydrophobic area and the hydrophilic area; and 144, water generated by the oxidizer electrode.

However, in this position, in the case where plural cells are stacked and used in the fuel cell system, although it is possible to supply water to outermost cells, it is difficult to supply water to cells between the outermost cells. In such a case, it is effective to provide the water supply port and the water retention section on a side distant from the drainage retention section of the fuel cell system, that is, in the position of (c).

As the polymer electrolyte membrane 112 serving as the ion conductor, Nafion 117 (trade name, manufactured by Du Pont) or the like can be used. In this case, when a voltage between the anode and the cathode is 3 V, a flowing current is 1 A/cm² at 25° C. Since a size of the cell is 1.2 cm×2 cm, a total area at the time when eight cells are used is 19.2 cm², and a flowing current is 19.2 A. A generation amount of hydrogen at this point is 3.4×10⁻⁵ g per second. Therefore, time required for charging is about 3.3 hours. In this case, an amount of consumption of water is 3.23×10⁻⁴ cm³ per second, which is an amount that can be supplied sufficiently by the water supply method using the capillary action.

As shown in FIG. 3, progress of charging is monitored according to a value of the pressure sensor 17 mounted on the fuel cell system. In the case where a value of the pressure sensor has exceeded a fixed value (e.g., about 0.2 MPa), a charging stop signal is sent to the charger to disconnect a circuit and stop the charging, and an indication of the end of charging is shown on the residual amount display section 25. In this way, overcharge can be prevented and an internal pressure of the fuel tank can be prevented from becoming high.

### Fourth Embodiment

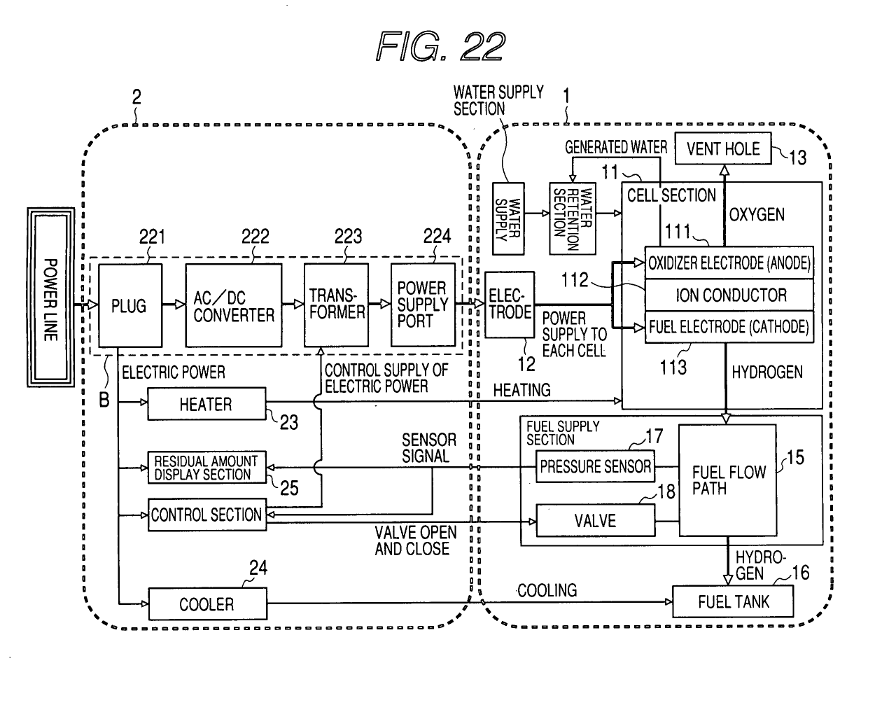

FIG. 22 shows a fourth embodiment and shows another schematic example of a correlation of a system of the charger and the fuel cell system of the present invention. The fourth embodiment is different from the first embodiment in that the water supply section is not provided in the charger. In this case, water may be separately supplied to the fuel cell system from the water retention section of the fuel cell system instead of supplying from the charger 2.

When water is supplied to the water supply section, the supplied water reaches the cell section 11 through the water retention section. It is advisable to guide water generated in the oxidizer electrode at the time of power generation (discharge) to the water retention section to thereby reuse the water at the time of charging.

As in the first embodiment, fuel (hydrogen) generated by the charging operation is guided to the fuel tank 16 through the fuel flow path 15. The control section of the charger 2 controls opening and closing of a power supply means B and the valve according to an internal pressure of the fuel tank 16, whereby the internal pressure of the fuel tank 16 can be prevented from increasing excessively. Consequently, the fuel cell system can be charged safely.

### Fifth Embodiment

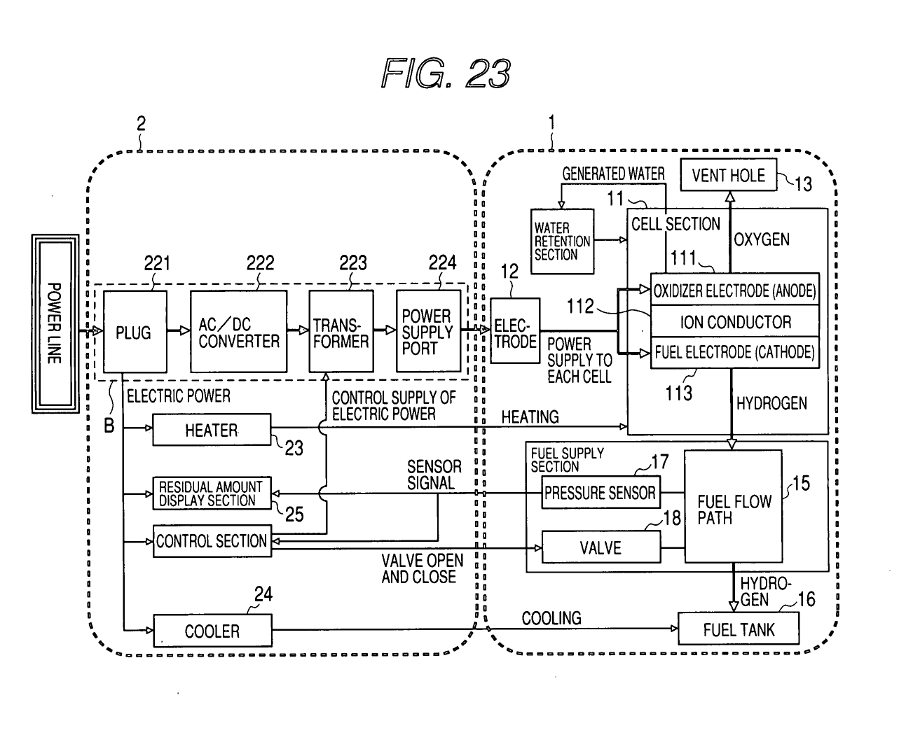

FIG. 23 shows a fifth embodiment and shows another schematic example of a correlation of a system of the charger and the fuel cell system of the present invention. The fifth embodiment is different from the fourth embodiment in that the water supply section is not provided in the fuel cell system. At the time of charging, water is supplied to the cell section from the water retention section in which water generated at the time of power generation (discharge) is stored. This form is effective in the case where water generated by power generation (discharge) does not decrease much.

In the present invention, as a method of storing hydrogen, first, there is a method of compressing hydrogen and storing the hydrogen as high pressure gas, second, there is a method of cooling hydrogen and storing the hydrogen as liquid, and, third, there is a method of storing hydrogen using a hydrogen occlusion alloy. The present invention can be applied to all of these methods.

In order to store fuel at a high density, a carbon material such as a carbon nanotube, a graphite nano-fiber, or a carbon nano-horn, or chemical hydride may be used.

The fuel cell system of the present invention can be preferably applied to a proton exchange membrane fuel cell with an amount of power generation of several milliwatts to several hundreds watts that can be mounted on, in particular, portable small-sized electric appliances such as a digital camera, a digital video camera, a small-sized projector, a small-sized printer, and a notebook personal computer.

In addition, the charger of the present invention can be preferably applied to charging for the fuel cell system. Further, the control section, which controls the residual amount display section and opening and closing of the valve, may be provided in the fuel cell system instead of the charger. It is rather preferable to provide the control section in the charger because the fuel cell system is made smaller.

### INDUSTRIAL APPLICABILITY

As described above, according to the present invention, a chargeable charger, which supplies hydrogen generated by electrolyzing water to a fuel tank of a fuel cell system, can be provided.

In addition, according to the method of charging a fuel cell system of the present invention, charging for supplying hydrogen generated by electrolyzing water to a fuel tank of a fuel cell system can be performed easily.

1. A charger for generating hydrogen, which is stored in a fuel tank of a fuel cell system, by electrolyzing water in an inside of the fuel cell system, comprising:
water supply means that supplies water to the fuel cell system; and
power supply means that supplies electric power to a power intake electrode of the fuel cell system that takes in electric power for electrolyzing water supplied to the fuel cell system to generate hydrogen.

2. A charger according to claim 1, wherein a power supply port of the power supply means is connected to the power intake electrode of the fuel cell system in a state in which the power supply port and the power intake electrode are insulated from an outside.

3. A charger according to claim 1, wherein the power supply means includes: a plug for obtaining AC power supply from an outside; a DC converter for converting the AC power supply into a direct current; a transformer for transforming DC power supply into a voltage matched to a charging voltage of the fuel cell system; and a power supply port that supplies the transformed power supply to the power intake electrode of the fuel cell system.

4. A charger according to claim 1, wherein the water supply means comprises means that supplies water in a state in which the fuel cell system is immersed in the water.

5. A charger according to claim 1, wherein the water supply means comprises means that changes water into a mist state and supplies the water to the fuel cell system.

6. A charger according to claim 1, further comprising a cooler that cools the fuel tank of the fuel cell system in a state in which the fuel cell system is attached to the charger.

7. A charger according to claim 1, further comprising a heater that heats a cell section of the fuel cell system in a state in which the fuel cell system is attached to the charger.

8. A charger according to claim 1, wherein the power supply means further includes power control means that controls electric power to be supplied to the fuel cell system.

9. A charger according to claim 8, wherein the power control means controls electric power to be supplied to the fuel cell system on the basis of a signal from a pressure sensor provided in the fuel tank of the fuel cell system.

10. A charger according to claim 1, further comprising valve control means that opens and closes a fuel supply valve provided in a fuel flow path, which introduces generated hydrogen to the fuel tank, on the basis of a signal concerning a pressure of hydrogen from a pressure sensor provided in the fuel tank of the fuel cell system.

11. A charger according to claim 1, further comprising a residual capacity detecting means that displays a residual amount of fuel in the fuel tank of the fuel cell system on the basis of a signal concerning a pressure of hydrogen from a pressure sensor provided in the fuel tank of the fuel cell system.

12. A charger for generating hydrogen, which is stored in a fuel tank of a fuel cell system, by electrolyzing water in an inside of the fuel cell system, comprising:
power supply means that supplies electric power to a power intake electrode of the fuel cell system that takes in electric power for electrolyzing water in the inside of the fuel cell system to generate hydrogen; and
power control means that controls electric power to be supplied to the fuel cell system by the power supply means on the basis of a signal from a pressure sensor provided in the fuel tank of the fuel cell system.

13. A charger for generating hydrogen, which is stored in a fuel tank of a fuel cell system, by electrolyzing water in an inside of the fuel cell system, comprising:
power supply means that supplies electric power to a power intake electrode of the fuel cell system that takes in electric power for electrolyzing water in the inside of the fuel cell system to generate hydrogen; and
valve control means that opens and closes a fuel supply valve provided in a fuel flow path, which introduces generated hydrogen to the fuel tank, on the basis of a signal concerning a pressure of hydrogen from a pressure sensor provided in the fuel tank of the fuel cell system.

14. A fuel cell system that stores hydrogen, which is generated by electrolyzing at least water supplied from an outside, in a fuel tank, comprising:
a cell section including an electrode to which an oxidizer is supplied, an electrode to which fuel is supplied, and an ion conductor that is held between the electrode to which an oxidizer is supplied and the electrode to which fuel is supplied;
a water supply section that supplies water supplied from the outside to the ion conductor of the cell section;
a power intake electrode that takes in electric power for electrolyzing water supplied from the water supply section to generate hydrogen from the outside; and
a fuel tank in which the generated hydrogen is stored.

15. A fuel cell system according to claim 14, wherein the water supply section includes: a water retention section that retains the water supplied from the outside; and a water flow path that supplies water held in the water retention section to the ion conductor.

16. A fuel cell system according to claim 14, wherein the water supply section includes: a water retention section that retains the water supplied from the outside and water generated by discharge of the cell section; and a water flow path that supplies the water held in the water retention section to the ion conductor.

17. A fuel cell system according to claim 14, wherein the power intake electrode serves as a power discharge electrode at a time of discharge of the fuel cell system.

18. A fuel cell system according to claim 14, wherein the electric power from the outside taken in from the power intake electrode is applied to the electrode to which an oxidizer is supplied and the electrode to which fuel is supplied, and electrolyzes the water supplied to the ion conductor.

19. A fuel cell system according to claim 14, further comprising a pressure sensor that is provided in the fuel tank, wherein a signal concerning a pressure of hydrogen from the pressure sensor is used for control of electric power to be supplied to the fuel cell system.

20. A fuel cell system according to claim 14, further comprising:
a pressure sensor that is provided in the fuel tank; and
a fuel supply valve that is provided in a fuel flow path, which introduces generated hydrogen to the fuel tank, and is opened and closed on the basis of a signal concerning a pressure of hydrogen from the pressure sensor.

21. A fuel cell system according to claim 14, further comprising:
a pressure sensor that is provided in the fuel tank; and
a residual capacity display section that displays a residual amount of fuel in the fuel tank of the fuel cell system on the basis of a signal from the pressure sensor.

22. A fuel cell system according to claim 14, further comprising a cooler that cools the fuel tank.

23. A fuel cell system according to claim 14, further comprising a heater that heats the cell section.

24. A fuel cell system that stores hydrogen, which is generated by electrolyzing water generated by discharge, comprising:
a cell section including an electrode to which an oxidizer is supplied, an electrode to which fuel is supplied, and an ion conductor that is held between the electrode to which an oxidizer is supplied and the electrode to which fuel is supplied;
a water supply section that supplies water generated by discharge to the ion conductor of the cell section;
a power intake electrode that takes in electric power for electrolyzing water supplied from the water supply section to generate hydrogen from the outside; and
a fuel tank in which the generated hydrogen is stored.

25. A fuel cell system according to claim 24, wherein the water supply section includes: a water retention section that retains the water generated by discharge; and a water flow path that supplies water held in the water retention section to the ion conductor.

26. A fuel cell system according to claim 24, wherein the power intake electrode serves as a power discharge electrode at a time of discharge of the fuel cell system.

27. A fuel cell system according to claim 24, wherein the electric power from the outside taken in from the power intake electrode is applied to the electrode to which an oxidizer is supplied and the electrode to which fuel is supplied, and electrolyzes the water supplied to the ion conductor.

28. A fuel cell system according to claim 24, further comprising a pressure sensor that is provided in the fuel tank, wherein a signal concerning a pressure of hydrogen from the pressure sensor is used for control of electric power to be supplied to the fuel cell system.

29. A fuel cell system according to claim 24, further comprising:
a pressure sensor that is provided in the fuel tank; and
a fuel supply valve that is provided in a fuel flow path, which introduces generated hydrogen to the fuel tank, and is opened and closed on the basis of a signal concerning a pressure of hydrogen from the pressure sensor.

30. A fuel cell system according to claim 24, further comprising:
a pressure sensor that is provided in the fuel tank; and
a residual capacity display section that displays a residual amount of fuel in the fuel tank of the fuel cell system on the basis of a signal from the pressure sensor.

31. A fuel cell system according to claim 24, further comprising a cooler that cools the fuel tank.

32. A fuel cell system according to claim 24, further comprising a heater that heats the cell section.

33. A method of charging a fuel cell system that stores hydrogen, which is generated by electrolyzing supplied water, in a fuel tank, comprising:
a step of supplying at least water supplied from an outside of the fuel cell system to an ion conductor constituting a cell section of the fuel cell system;
a step of electrolyzing the water supplied to the ion conductor with electric power taken in from the outside of the fuel cell system to generate hydrogen; and
a step of introducing the generated hydrogen to the fuel tank of the fuel cell system.

34. A method of charging a fuel cell system according to claim 33, wherein the supplied water comprises at least one of water supplied from the outside and water generated by discharge of the fuel cell system.

35. A method of charging a fuel cell system according to claim 33, wherein the supplied water is held by a water retention section and then supplied to the ion conductor through a water flow path.

36. A method of charging a fuel cell system according to claim 33, wherein the fuel cell system includes a power intake electrode for taking in electric power from the outside, and the power intake electrode serves as a power discharge electrode at a time of discharge of the fuel cell system.

37. A method of charging a fuel cell system according to claim 33, wherein electric power taken in from the outside is applied to an electrode to which an oxidizer is supplied and an electrode to which fuel is supplied, the electrodes constituting the cell section, and electrolyzes the water supplied to the ion conductor.

38. A method of charging a fuel cell system according to claim 33, wherein electric power supplied to the fuel cell system is controlled on the basis of a pressure in the fuel tank.

39. A method of charging a fuel cell system according to claim 33, wherein opening and closing of a fuel supply valve provided in a fuel flow path, which introduces generated hydrogen to the fuel tank, is controlled on the basis of a pressure in the fuel tank.

40. A method of charging a fuel cell system according to claim 33, wherein a residual amount of fuel in the fuel tank, which is calculated on the basis of a pressure in the fuel tank, is displayed on a residual capacity display section.

41. A method of charging a fuel cell system according to claim 33, wherein the fuel tank is cooled.

42. A method of charging a fuel cell system according to claim 33, wherein the cell section is heated.
